(19) United States
(12) Patent Application Publication
(10) Pub. No.: US 2012/0084125 A1
(43) Pub. Date: Apr. 5, 2012

(54) Search Change Model

(76) Inventors: David Xi-Kuan Chan, Edgewater, NJ (US); Ori Gershony, Redmond, WA (US); James R. Koehler, Boulder, CO (US); Andrei Pascovici, Bellevue, WA (US); Jian L. Silverstein, Palo Alto, CA (US); Yuan Yuan, Mountain View, CA (US)

(21) Appl. No.: 13/252,479

(22) Filed: Oct. 4, 2011

Related U.S. Application Data
(60) Provisional application No. 61/390,124, filed on Oct. 5, 2010.

(51) Int. Cl. G06Q 30/02

(52) U.S. Cl. 705/14.4

(57) ABSTRACT

Systems, methods and computer program products for determining lost opportunities resulting from changes to advertising spending are described. To assist advertisers in evaluating and allocating a proper budget to advertising, an analyzer can be used to develop an analytical model that gathers data pertaining to the incremental value of search advertising. (e.g., the true cost of the additional click lost or gained), which can be presented to the advertisers when changes have been made/proposed to the advertiser's advertising spending. The analyzer can detect large changes in advertising spending, and indicate (e.g., by prediction) how many total clicks were lost or gained as a result of the change in advertising spending to allow the advertisers to visualize the impact to changes in advertising spending, and determine when to decrease advertising budget on ads that yield low return-on-investment or to increase advertising budget to maximize the effectiveness of an active ad campaign.

### CROSS-REFERENCE TO RELATED APPLICATION

This application claims the benefit of priority to U.S. Provisional Application Ser. No. 61/390,124, filed on Oct. 5, 2010, under 35 U.S.C. §119(e). The disclosure of the prior application is considered part of and is incorporated herein by reference in the disclosure of this application.

### TECHNICAL FIELD

The subject matter of this application is generally related to information presentation.

### BACKGROUND

Online advertising is an important advertising medium that continues to grow rapidly as use of the Internet expands. A key objective for advertisers is to increase the efficiency and effectiveness of ad campaigns. The efficiency of an ad campaign can be improved through real time reporting of statistics on the performance of the respective advertisements (“ads”).

In managing the advertising spending to meet both financial and advertising goals, advertisers may not realize the immediate effects of a spending adjustment. As such advertisers may either over-spend on ads that are ineffective or under-spend on ads that are successful, which can result in lost sales and revenues for the advertisers.

### SUMMARY

Systems, methods and computer program products for determining lost opportunities resulting from changes to advertising spending are described. To assist advertisers in evaluating and allocating a proper budget to advertising, in some implementation, an analyzer can be used to develop an analytical model that gathers data pertaining to the incremental value of search advertising. (e.g., the true cost of the additional click lost or gained), which can be presented to the advertisers when changes have been made/proposed to the advertiser's advertising spending. In some implementations, the analyzer can detect large changes in advertising spending, and indicate (e.g., by prediction) how many total clicks were lost or gained as a result of the change in advertising spending. The analyzer also can present data showing the extent to which the advertiser's organic clicks generated from organic traffic make up for any loss or gain in paid clicks (e.g., clicks received through the advertiser's sponsored ad(s)). In so doing, the analyzer allows the advertisers to visualize the impact to changes in advertising spending, and determine more precisely when to decrease advertising budget on ads that yield low return-on-investment or to increase advertising budget to maximize the effectiveness of an active ad campaign.

In some implementations, a method can be provided that includes: identifying campaign information associated with an advertising campaign including identifying information associated with a change in advertising spending between a first period and a second period; developing a model based on the identified campaign information; predicting, based on the developed model, a number of total clicks that would have been received in the second period based on a first advertising spending in the first period, and a number of total clicks that would have been received in the second period based on a second advertising spending in the second period; determining a total click change resulting from the change in advertising spending based on the predicted number of total clicks associated with the first advertising spending and the second advertising spending; and determining a cannibalization rate based on the total click change.

In some implementations, predicting the number of total clicks that would have been received can include predicting a number of paid clicks and organic clicks that would have been received in the second period. In some implementations, predicting the number of paid clicks and organic clicks also can include predicting the number of paid clicks separately from predicting the number of organic clicks.

In some implementations, a number of organic clicks gained or lost as a result of the change in advertising spending also can be determined. In some implementations, the total click change can be determined based on the predicted number of total clicks associated with the first advertising spending and the second advertising spending, and the determined number of organic clicks gained or lost.

In some implementations, the number of organic clicks gained as a result of the change in advertising spending can be determined by determining a number of clicks cannibalized to organic traffic as a result of the change in advertising spending.

In some implementations, the campaign information can be identified by receiving information relating to the first advertising spending in the first period. The model then can be developed based on the identified campaign information and the information relating to the first advertising spending.

In some implementations, information associated with a change in advertising spending can be identified where an average daily spending over a predetermined interval that includes the first period and the second period can be determined.

In some implementations, the change in advertising spending can be detected based on the determined average daily spending, the change exceeding a predetermined threshold. Then, a date on which the detected change in advertising spending occurs can be identified, and the first period and the second period can be identified based on the identified date.

In some implementations, the total click change resulting from the change in advertising spending can be determined by determining an incremental value for organic clicks received from organic traffic and paid clicks received from paid traffic. In some implementations, determining the cannibalization rate can include determining a rate at which the organic clicks are replacing or lost to the paid clicks resulting from the change in advertising spending, the rate determined based at least in part on the incremental value. In some implementations, determining the cannibalization rate can include determining a rate at which the total click change is offset by organic clicks gained or lost during the second period.

In some implementations, a system can be provided that includes a database for storing campaign information associated with an advertising campaign; and an analyzer configured to: identify campaign information associated with an advertising campaign including identifying information associated with a change in advertising spending between a first period and a second period; develop a model based on the identified campaign information; predict, based on the developed model, a number of total clicks that would have been received in the second period based on a first advertising spending in the first period, and a number of total clicks that would have been received in the second period based on a second advertising spending in the second period; determine a total click change resulting from the change in advertising spending based on the predicted number of total clicks associated with the first advertising spending and the second advertising spending; and determine a cannibalization rate based on the total click change.

In some implementations, a computer-readable medium having instructions stored thereon, which, when executed by a processor, causes the processor to perform operations comprising: identifying campaign information associated with an advertising campaign including identifying information associated with a change in advertising spending between a first period and a second period; developing a model based on the identified campaign information; predicting, based on the developed model, a number of total clicks that would have been received in the second period based on a first advertising spending in the first period, and a number of total clicks that would have been received in the second period based on a second advertising spending in the second period; determining a total click change resulting from the change in advertising spending based on the predicted number of total clicks associated with the first advertising spending and the second advertising spending; and determining a cannibalization rate based on the total click change. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example content presentation system.

FIG. 2 is a data flow diagram showing an example data flow.

FIG. 3 is an example flow chart of a process for determining a cannibalization rate.

FIG. 4 is an example of a graph illustrating two periods during which significant change in advertising spending has occurred.

FIG. 5 is an example of a bar chart showing a total number of clicks received during a pre-spend change period and a total number of clicks received during a post-spend change period.

FIG. 6 is an example of a total clicks model graph showing traffic generated by organic searches and paid searches to an advertiser's web site.

FIG. 7 is an example of a bar graph showing a number of organic clicks gained from and a number of paid clicks list lost to organic traffic after advertising spending has changed.

FIG. 8 is a block diagram of generic processing device that may be used to execute methods and processes disclosed herein.

Like reference symbols in the various drawings indicate like elements.

### DETAILED DESCRIPTION

In bidding or sponsoring ads, setting an accurate spending forecast is paramount concern for many advertisers. Spending forecast can be used for campaign planning, ad inventory control, and other planning needs of the advertisers. An inaccurate spending forecast can subject the advertisers to over-spending on ads that are ineffective or under-spending on ads that are successful, which can result in lost sales and revenues for the advertisers.

In evaluating a proper budget for search advertising, some advertisers might not invest in brand term keywords, fearing that some of the search results might already appear through natural organic search, and therefore spending on what would otherwise be organic (free) clicks (e.g., clicks received through organic or natural searches). Other advertisers are reluctant to invest in keyword advertising or increase the allotted advertising budget due to the uncertainties of the return yields.

To assist the advertisers in evaluating and allocating a proper budget to search advertising, in some implementation, an analytical model can be developed that gathers data pertaining to lost opportunity (e.g., potential clicks that were missed), the results of which can be presented to the advertisers when changes have been made to the advertiser's advertising spending, or before such changes are implemented (e.g., as preview data). For example, upon detecting large changes in advertising spending, a corresponding loss (or gain) of total clicks can be predicted as a result of the change in advertising spending. In so doing, the advertisers can more accurately evaluate the impact to changes in advertising spending, and determine more precisely when to decrease advertising budget on ads that yield low return-on-investment or to increase advertising budget to maximize the effectiveness of an active ad campaign.

In some implementations, a cannibalization rate that reflects a rate at which a paid click loss (e.g., the rate at which paid clicks are lost as a result of budget adjustment) is offset by organic clicks (e.g., clicks gained from natural or organic searches) after changes are made to the advertising spending can be determined using the model data. The cannibalization rate can assist the advertisers in gauging the need to increase or decrease advertising spending, as will be discussed in greater detail below.

### System Overview

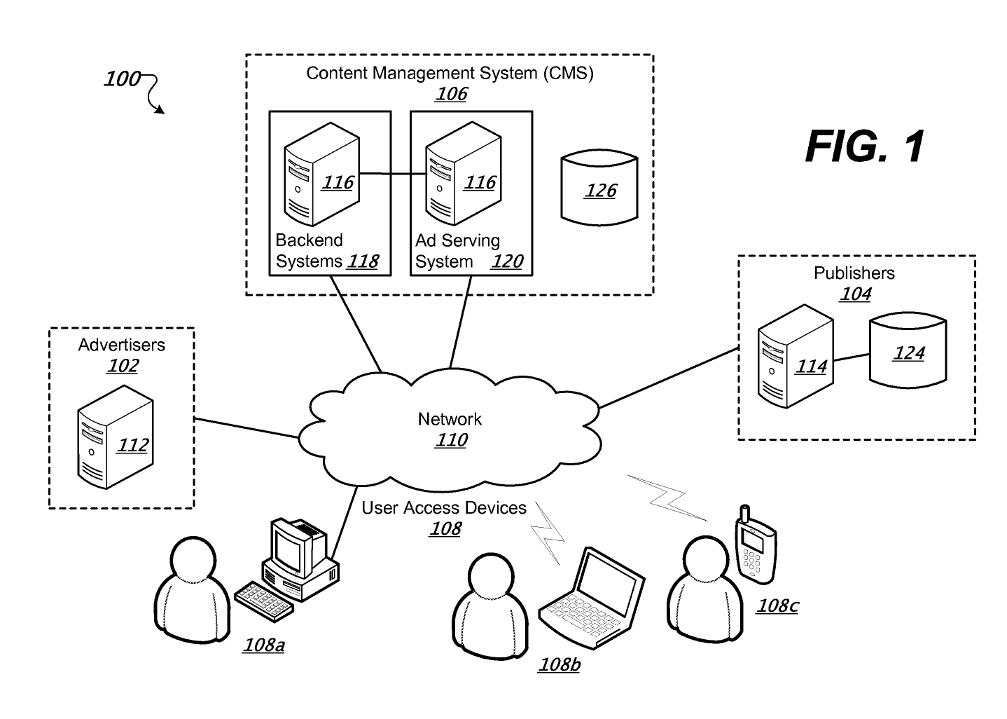

FIG. 1 is a block diagram showing an example content presentation system 100. The system 100 can receive and provide content to users, publishers, and advertisers. For example, the content can include web documents, links, images, advertisements, and other information. In some implementations, the system 100 can receive content from advertisers and deliver or serve the advertiser content to users along with other content (e.g., a publisher web page). In some implementations, the system 100 can select and deliver advertiser content that is contextually relevant to and of an appropriate format and style to the publisher content accessed.

In some implementations, content can include one or more advertisements. An advertisement or an “ad” can refer to any form of communication in which one or more products, services, ideas, messages, people, organizations or other items are identified and promoted. Ads need not be limited to commercial promotions or other communications. An ad can be a public service announcement or any other type of notice, such as a public notice published in printed or electronic press or a broadcast. An ad can be referred to or include sponsored content.

In some implementations, ads can be communicated via various mediums and in various forms. For example, ads can be communicated through an interactive medium, such as the internet, and can include graphical ads (e.g., banner ads), textual ads, image ads, audio ads, video ads, ads combining one of more of any of such components, or any form of electronically delivered advertisement. Ads can include embedded information, such as embedded media, links, meta-information, and/or machine executable instructions. Ads can also be communicated through RSS (Really Simple Syndication) feeds, radio channels, television channels, print media, and other media.

The term “ad” can refer to either a single “creative” and/or an “ad group.” A creative can be any content that represents one ad impression. An ad impression refers to any form of presentation of an ad such that it is viewable/receivable to a user. In some implementations, an ad impression can occur when displaying an ad on a display device of a user access device. An ad group can be an entity that represents a group of creatives that share a common characteristic, such as having the same ad targeting criteria. Ad groups can be used to create an ad campaign.

In some implementations, ads can be embedded within other content. For example, ads (e.g., newspaper subscription advertisement) can be displayed with other content (e.g., newspaper articles) in a web page associated with a publisher (e.g., a news content provider). When displayed, the ads can occupy an ad space “slot” or “block.” Ad space can include any space that allows rendering/presentation of information (i.e., associated with a given ad). In some examples, the ad space can be implemented as a HyperText Markup Language (HTML) element, such as an inline frame (I-Frame) or other type of embeddable display element. The ad space can include any portion, or all, of a user display. The ad space can be a discrete, isolated portion of a display or blended and dispersed throughout a display. The ad space can be a discrete element or dispersed in multiple sub-elements.

In some implementations, ads can be integrated with the surrounding content of the web page they are displayed with, prior to viewing by a user. For example, the rendering of the text of an ad can be in the same or a complementary size, color, and font type as the text on the web page into which it is integrated. In addition, the ad can be displayed using the same color scheme or chrome of the surrounding web page into which it is integrated. Typically, the better integrated into its web page surroundings an ad is, the better the ad will perform in terms of notice and interaction by a user.

In some implementations, the advertising system 100 can dynamically determine how to render/present an ad. For example, the advertising system 100 can determine how much space a particular ad can occupy. Moreover, the advertising system 100 can determine if the ad can be expanded, shrunk, side-barred, bannered, popped up, or otherwise displayed alone or with other ads within a specific publisher's website. For example, the advertising system 100 can use ad features (e.g., title, text, links, executable code, images, audio, embedded information, targeting criteria, etc.) to identify if an ad can be served in a particular ad block.

In determining how to render/present an ad, the advertising system 100 can determine how to best integrate the ad into its web page surroundings. Prior to rendering the ad, the advertising system 100 can determine specific data related to the web page (e.g., types of fonts used, colors, font sizes, color scheme used by the web page, etc.). Using this data, the advertising system 100 can select fonts, colors, font sizes, chromes, etc. that can best render the ad in order for it to integrate well into the web page.

A “click-through” of a displayed ad can occur when a user clicks or otherwise selects/interacts with the ad. A “conversion” can occur, for example, when a user consummates a transaction related to a given ad. For example, a conversion can occur when a user clicks on an ad, which refers them to the advertiser's web page, and consummates a purchase on the advertiser's web page before leaving that web page. In another example, a conversion can be the display of an ad to a user and a corresponding purchase on the advertiser's web page within a predetermined time (e.g., seven days).

As shown in FIG. 1, the advertising system 100 can include one or more content providers (e.g., advertisers 102), one or more publishers 104, a content management system (CMS) 106, and one or more user access devices 108 (user access device 108a, user access device 108b, user access device 108c). All of the elements can be coupled to a network 110. Each of the elements 102, 104, 106, 108, and 110 in FIG. 1 can be implemented or associated with hardware components, software components, or firmware components, or any combination of such components. For example, the elements 102, 104, 106, 108, and 110 can be implemented or associated with general purpose servers, software processes and engines, and/or various embedded systems. For example, the elements 102, 104, 106, and 110 can serve as an ad distribution network. While reference is made to distributing advertisements, the system 100 can be suitable for distributing other forms of content including other forms of sponsored content.

The advertisers 102 can include any entities that are associated with ads. The advertisers 102 can provide, or be associated with, products and/or services related to ads. For example, the advertisers 102 can include, or be associated with, retailers, wholesalers, warehouses, manufacturers, distributors, health care providers, educational establishments, financial establishments, technology providers, energy providers, utility providers, or any other product or service providers or distributors.

The advertisers 102 can directly or indirectly generate, maintain, and/or track ads, which can be related to products or services offered by or otherwise associated with the advertisers. The advertisers 102 can include, or maintain, one or more data processing systems 112, such as servers or embedded systems, coupled to the network 110. The advertisers 102 can include or maintain one or more processes that run on one or more data processing systems.

The publishers 104 can include any entities that generate, maintain, provide, present, and/or process content in the advertising system 100. The publisher “content” can include various types of content including web-based information, such as articles, discussion threads, reports, analyses, financial statements, music, video, graphics, search results, web page listings, information feeds (e.g., RSS feeds), television broadcasts, radio broadcasts, printed publications, etc. The publishers 104 can include or maintain one or more data processing systems 114, such as servers or embedded systems, coupled to the network 110. The publishers 104 can include or maintain one or more processes that run on data processing systems. In some implementations, the publishers 104 can include one or more content repositories 124 for storing content and other information.

In some implementations, the publishers 104 can include content providers. For example, content providers can include those with an internet presence, such as online publication and news providers (e.g., online newspapers, online magazines, television websites, etc.), or online service providers (e.g., financial service providers, health service providers, etc,). The publishers 104 can also include television broadcasters, radio broadcasters, satellite broadcasters, print publishers and other content providers. One or more of the publishers 104 can represent a content network that is associated with the CMS 106.

In some implementations, the publishers 104 can include search services. For example, search services can include those with an internet presence, such as online search services that search the worldwide web, online knowledge database search services (e.g., dictionaries, encyclopedias), etc.

The publishers 104 can provide or present content via various mediums and in various forms, including web based and non-web based mediums and forms. The publishers 104 can generate and/or maintain such content and/or retrieve the content from other network resources.

The CMS 106 can manage content (e.g., ads) and provide various services to the advertisers 102, the publishers 104, and the user access devices 108. The CMS 106 can store ads in a repository 126 and facilitate the distribution or targeting of ads through the advertising system 100 to the user access devices 108.

The CMS 106 can include one or more data processing systems 116, such as servers or embedded systems, coupled to the network 110. The CMS 106 can also include one or more processes, such as server processes. In some implementations, the CMS 106 can include an ad serving system 120 and one or more backend processing systems 118. The ad serving system 120 can include one or more data processing systems 116 and can perform functionality associated with delivering ads to publishers or user access devices. The backend processing systems 118 can include one or more data processing systems 116. The backend processing systems 118 can perform functionality associated with identifying relevant ads to deliver, customizing ads, performing filtering processes, generating reports, maintaining accounts and usage information, and other backend system processing. The CMS 106 can use the backend processing systems 118 and the ad serving system 120 to distribute ads from the advertisers 102 through the publishers 104 to the user access devices 108.

In some implementations, the CMS 106 can provide various features to the publishers 104. The CMS 106 can deliver ads (associated with the advertisers 102) to the user access devices 108 when users access content from the publishers 104. For example, the CMS 106 can deliver ads that are relevant to publisher sites, site content, and publisher audiences. In another example, the CMS 106 can allow the publishers 104 to search and select specific products and services as well as associated ads displayed with content provided by the publishers 104. In some implementations, the publishers 104 can search through ads in the ad repository 126 and select certain ads for display with their content.

The user access devices 108 can include devices capable of receiving information from the network 110. The user access devices 108 can include general computing components and/or embedded systems optimized with specific components for performing specific tasks. Examples of user access devices 108 can include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, and other electronic devices. The user access devices 108 can also include various other elements, such as processes running on various machines. In some implementations, the user access devices are not electronic (e.g., printed publications).

The network 110 can include any element or system that facilitates communications among and between various network nodes, such as elements 108, 112, 114, and 116. The network 110 can include one or more telecommunications networks, such as computer networks, telephone or other communications networks, the internet, etc. The network 110 can include a shared, public, or private data network (e.g., an intranet, a peer-to-peer network, a private network, a virtual private network (VPN), etc.) encompassing a wide area (e.g., WAN) or local area (e.g., LAN). In some implementations, the network 110 can facilitate data exchange by way of packet switching using the Internet Protocol (IP). The network 110 can also facilitate wired and/or wireless connectivity and communication.

In some implementations, user access devices 108 and advertisers 102 can provide usage information to the CMS 106 (e.g., whether or not a conversion or click-through related to an ad has occurred). This usage information can include measured or observed user behavior related to served content. For example, the CMS 106 can perform financial transactions, such as crediting publishers 104 and charging advertisers 102 based on the usage information.

In some implementations, a publisher can be a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia, and in U.S. Pat. No. 6,285,999, both of which are incorporated herein by reference each in their entirety. For example, search results can include lists of web page titles, snippets of text extracted from those web pages, and hypertext links to those web pages, and can be grouped into a predetermined number of search results.

For example, a publisher (e.g., one of the publishers 104) can receive a search query request from a user access device (e.g., user access device 108a). In response, the publisher can retrieve relevant search results for the query from an index of documents (e.g., an index of web pages, which can be included in a content repository 124). The publisher can also submit a request for ads to the CMS 106. The ad request can include the desired number of ads. The number of requested ads can, for example, depend on the search results, the amount of screen or page space occupied by the search results, the size and shape of the requested ads, etc. The ad request can also include the search query (as entered or parsed), information based on the query (e.g., geo-location information, whether the query came from an affiliate and an identifier of such an affiliate, etc.), and/or information associated with, or based on, the search results. For example, the information can include identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from dot products of feature vectors corresponding to a search query and document, page rank scores, and/or combinations of IR scores and page rank scores, etc.

A user access device (e.g., user access device 108a) can present in a viewer (e.g., a browser or other content display system) the search results integrated with one or more of the ads provided by the CMS 106. In some implementations, the user access device can transmit information about the ads back to the CMS 106, including information describing how, when, and/or where the ads are to be/were rendered/presented (e.g., in HTML or JavaScript®).

In some implementations, a publisher can be a general content provider. For example, a publisher (e.g., one of the publishers 104) can receive a request for content from a user access device (e.g., user access devices 108a). In response, the publisher can retrieve the requested content (e.g., access the requested content from the content repository 124) and provide or present the content to the user access device 108a. The publisher can also submit a request for ads to the CMS 106. The ad request can include the desired number of ads. The ad request can also include content request information. This information can include, for example, the content itself (e.g., the web page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc. In response to the ads request, the CMS 106 can retrieve the requested ads (e.g., access the requested ads from the ad repository 126) and provide or present the ads to the requesting publisher.

A user access device (e.g., user access device 108a) can present in a viewer (e.g., a browser or other content display system) the content integrated with one or more of the ads provided by the CMS 106. In some implementations, the user access device can transmit information about the ads back to the CMS 106, including information describing how, when, and/or where the ads are to be/were rendered (e.g., in HTML or JavaScript®).

For purposes of explanation only, certain aspects of this disclosure are described with reference to the discrete elements illustrated in FIG. 1. The number, identity and arrangement of elements in the system 100 are not limited to what is shown. For example, the system 100 can include any number of geographically-dispersed advertisers 102, publishers 104 and/or user access devices 108, which can be discrete, integrated modules or distributed systems. Similarly, the system 100 is not limited to a single CMS 106 and can include any number of integrated or distributed CMS systems or elements.

Furthermore, additional and/or different elements not shown can be contained in or coupled to the elements shown in FIG. 1, and/or certain illustrated elements can be absent. In some examples, the functions provided by the illustrated elements could be performed by less than the illustrated number of components or even by a single element. The illustrated elements could be implemented as individual processes run on separate machines or a single process running on a single machine.

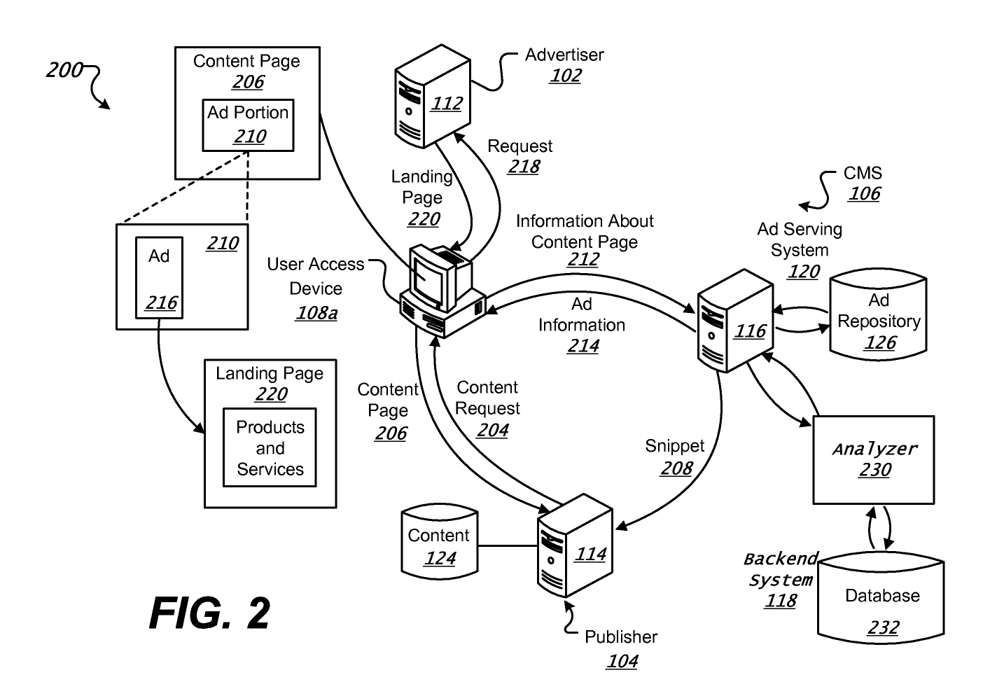

FIG. 2 is a data flow diagram showing an example data flow 200. In particular, the data flow 200 shows ad component interactions when ads are being served (e.g., by the advertising system 100). It should be noted that the data flow 200 is merely an example illustration and not intended to be restrictive. Other data flows are possible, and the illustrated events and their particular order in time can vary depending on a specific design and application.

As shown in FIG. 2, a publisher 104a can receive a content request 204 from the user access device 108a. For example, the content request 204 can be a request for a web document on a given topic (e.g., pet food suppliers). In response to the request 204, the publisher can retrieve relevant content (e.g., the web page for ExamplePetSupplyRetailer) from the content repository 124.

The publisher 104a can respond to the content request 204 by sending a content page 206 or other presentation, representation, or characterization of the content to the requesting user access device 108a. The content page 206 can include the requested content (e.g., the web page for ExamplePetSupplyRetailer) as well as a code snippet 208 associated with an ad. For example, a code snippet can refer to a method used by one device (e.g., a server) to ask another device (e.g., a browser running on a client device) to perform actions after or while downloading information. In some implementations, a code snippet can be in JavaScript® code or can be part of the HTML or other web page markup language or content.

In some implementations, the CMS 106 can send the code snippet 208 to the publisher 104a and/or the user access device 108a. In some implementations, the code snippet 208 can originate and/or be provided from other sources. As the requesting user access device 108a loads the content page 206, the code snippet 208 causes the user access device 108a to contact the CMS 106 and receive additional code (e.g., Java Script®), which causes the content page 206 to load with an ad portion 210.

The ad portion 210 can be similar to, or include, an ad block. The ad portion 210 can include any element that allows embedding/including of information within the content page 206. In some implementations, the ad portion 210 can be an HTML element (e.g., an I-Frame) or other type of frame.

In some implementations, the ad portion 210 can be hosted by the CMS 106 or the publisher 104a and can allow content (e.g., ads) from the CMS 106 or the publisher 104a to be embedded inside the content page 206. Parameters associated with the ad portion 210 (e.g., its size, shape, and other style characteristics) can be specified in the content page 206 (e.g., in HTML), so that the user access device 108a can present the content page 206 while the ad portion 210 is being loaded.

In general, when a user clicks on or otherwise interacts with the displayed ad 216, an embedded code snippet can direct the user access device 108a to contact the CMS 106. During this event, the user access device 108a can receive an information parcel, such as a signed browser cookie, from the CMS 106. This information parcel can include information, such as an identifier of the selected ad 216, an identifier of the publisher 104a, and the date/time the ad 216 was selected by the user. The information parcel can facilitate processing of conversion activities or other user transactions.

The user access device 108a can then be redirected to the advertiser 102 associated with the selected ad 216. The user access device 108a can send a request 218 to the associated advertiser 102 and then load a landing page 220 from the advertiser 102. The user can then, for example, perform a conversion action at the landing page 220, such as purchasing a product or service, registering, joining a mailing list, etc. The CMS 106 can provide a code snippet, which can be included within a conversion confirmation page script such as a script within a web page presented after the purchase. The user access device 108a can execute the code snippet, which can contact the CMS 106 and report conversion data to the CMS 106. The conversion data can include conversion types and numbers as well as information from cookies. The conversion data can be maintained in a conversion data repository.

### Organic Clicks and Paid Clicks

The CMS 106 can facilitate various types of content delivery. For example, the CMS 106 can generate natural or organic search results that are algorithmically derived through the application of various search rules. Natural or organic search results generally include results that are not normally influenced by commercial considerations, unlike sponsored links and ads. The formulation of organic search results also may be based on user-specific factors, such as personalized data including, for example, user demographics, prior search behavior (by the user and other users), user bookmarks, collaborative filtering techniques, the locale associated with the user, the time of day, the freshness/age of the contents of the web pages, and other well-known criteria. The page and the order in which the ads are displayed along side the organic search results are typically determined with reference to the amount each respective advertiser has bid for the keyword.

The CMS 106 also can generate search results that are based on paid, bid, or sponsored links and placements (e.g., paid or sponsored ads). The inclusion and order of paid search results are typically determined through the application of various business rules driven by relevancy and prices bid by the content providers. Content providers such as advertisers can bid on keywords which, when included in search queries entered by users in a search engine, result in ads from the advertisers being shown along with the organic search results in response to the search query.

In bidding or sponsoring ads, setting an accurate spending forecast (e.g., factors that could affect budget, bids, keywords, and similar advertising attributes) is of paramount concern for many advertisers. Spending forecast can be used for campaign planning, ad inventory control, and other planning needs of the advertisers. An inaccurate spending forecast can subject the advertisers to over-spending on ads that are ineffective or under-spending on ads that are successful, which can result in lost sales and revenues for the advertisers.

As an example, an advertiser who presents the highest bid may win all of the advertising opportunities available early in an auction period, but will have its auction budget depleted early compared to other bidders. As another example, an advertiser who presents a relatively low bid but a large budget may not win any advertising opportunities early in an auction period until other advertisers' auction budgets are depleted, at which time sales and other profitable opportunity might have already been lost.

Also, in evaluating a proper budget for advertising, some advertisers might not invest in brand term keywords, fearing that some of the search results might already appear through natural organic search, and therefore spending on what would otherwise be organic (free) clicks (e.g., clicks received through organic or natural searches). Other advertisers are reluctant to invest in keyword advertising or increase the allotted advertising budget due to the uncertainties of the return yields.

To assist the advertisers in evaluating and allocating a proper budget to advertising, in some implementation, an analyzer 230 can be used to develop an analytical model that gathers data pertaining to the incremental value of search advertising (e.g., the true cost of the additional click lost or gained), which can be presented to the advertisers when changes have been made/proposed to the advertiser's advertising spending. In some implementations, the analyzer 230 can detect large changes in advertising spending, and indicate (e.g., by prediction) how many total clicks were lost or gained as a result of the change in advertising spending. The analyzer 230 also can present data showing the extent to which the advertiser's organic clicks generated from organic traffic make up for any loss or gain in paid clicks (e.g., clicks received through the advertiser's sponsored ad(s)). In so doing, the analyzer 230 allows the advertisers to visualize the impact to changes in advertising spending, and determine more precisely when to decrease advertising spending on ads that yield low return-on-investment or to increase advertising spending to maximize the effectiveness of an active ad campaign.

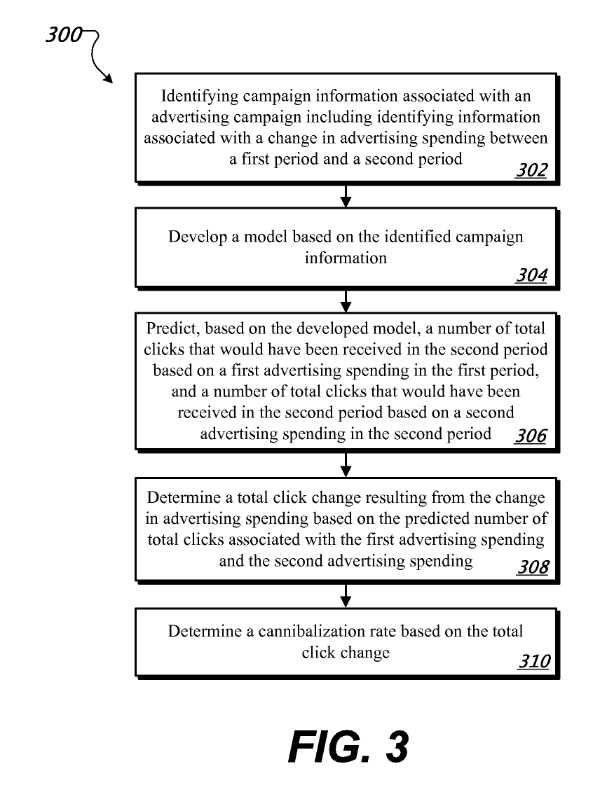

In some implementations, a cannibalization rate can be determined by the analyzer 230 to assist advertisers in gauging the need to increase or decrease advertising spending. In some implementations, the cannibalization rate is defined as the percentage of clicks (or other kinds of interaction or conversion) generated by an ad that would otherwise have been obtained through organic clicks had the ad not been published and running. In other words, the cannibalization rate indicates the number of paid clicks (e.g., as generated by the advertiser's paid ad) that would have come naturally through organic traffic, or the rate at which organic clicks are replacing or lost to paid clicks. FIG. 3 is an example flow chart of a process 300 for determining the cannibalization rate. The process 300 can be performed, for example, by the analyzer 230, and for clarity of presentation, the description that follows uses the analyzer 230 as the basis of examples for describing the process 300. However, another system or combination of devices and systems also can be used to perform the process 300.

Referring to FIG. 3, at 302, campaign information associated with an advertising campaign can be identified. The campaign information can be at a single campaign level or it can be an aggregation of multiple campaigns. In some implementation, the campaign information can include information associated with a change in advertising spending between a first period and a second period. The change, in some implementations can be real (e.g., as actually requested by the advertiser or system managing the advertising campaign) or proposed. In some implementations, the advertising spending can include budget information used for managing ad listings and auction bids. In some implementations, the budget information can be a daily budget, or a monthly budget. As advertising campaign information are submitted or updated to CMS 106, the analyzer 230 can update the cannibalization rate (e.g., on a hourly, daily, weekly, or monthly basis). In some implementations, other campaign information also can be received including information such as, without limitation, campaign name, campaign settings, keywords, keyword settings (e.g., bid range, match type, target rank, etc.), negative keywords, ads, ad groups, targeting, budget and other parameters. In some implementations, the analyzer 230 can be coupled to a database 232 that stores campaign information associated with one or more ad campaigns hosted by the advertisers (e.g., data pertaining to bids, keywords, account information, and other campaign related signals and information).

In some implementations, one or more changes in an advertiser's advertising spending can be detected. In some implementations, the analyzer 230 can receive information from the CMS 106 indicating that the advertiser has updated its advertising spending. In some implementations, the advertiser may propose a spending change and desire to see suggested results or impact from such a change, and request the analyzer 230 to analyze the impact of the change before confirming the spending change. In some implementations, the analyzer 230 can employ information relating to the average daily spending to detect the change in the advertiser's advertising spending that might have exceeded (or fallen below) a predetermined threshold. Based on the average daily spending, the analyzer 230 can identify a date on which the detected change in advertising spending occurs.

For example, the analyzer 230 can automatically detect that an advertiser has significantly reduced the advertising spending on a particular date or between two periods. The date on which the analyzer 230 concludes a significant adjustment in advertising spending has occurred can depend on various factors. For example, in determining this critical date on which the advertiser has significantly changed the advertising spending, the analyzer 230 can consider, for example, an average daily spending over a given interval (e.g., within a 30-day period). The analyzer 230 can evaluate the average daily spending over the given interval, and identify two periods within the interval during which the average daily spending has exceeded or fallen below a predetermined average.

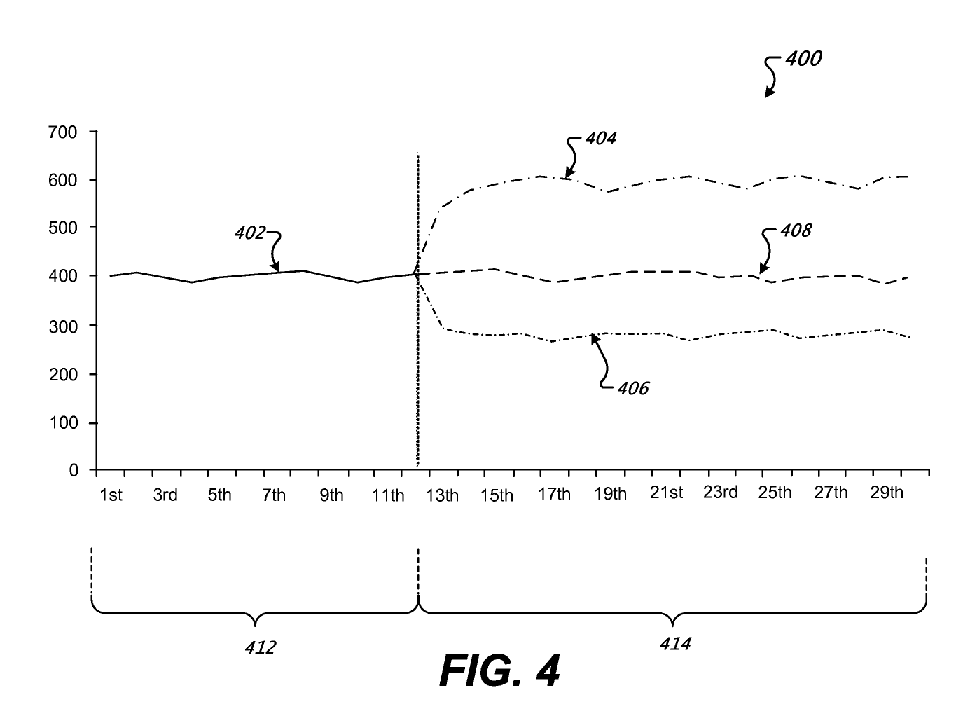

As an example, the analyzer 230 can detect that within a 30-day period, the average daily advertising spending of $100 per day for a first period starting from Day 1 to Day 11 is significantly higher than the average daily advertising spending of $50 per day for a second period starting from Day 12 to Day 30. In this example, the analyzer 230 can conclude that the advertiser has significantly reduced its advertising spending because the average daily spending during the second period has decreased by at least 50%. FIG. 4 shows an example of a graph 400 illustrating two periods during which significant change in advertising spending has occurred.

Referring to FIG. 4, the graph 404 shows an average spending line 402 before a change to the advertising spending has taken place (hereinafter “pre-spend change period”). As shown, the pre-spending change period 412 is relatively stable prior to the advertiser adjusting the advertising spending. The average spending line 402 indicates a steady spending over a period of 11 days (e.g., from 1^{st} to 11^{th}). On the 12^{th} day, the average spending experienced a sharp adjustment (e.g., from 12^{th} to 31^{st}) during which the average spending has decreased by roughly 50% as indicated by the average spending line 406. From the average daily spending, the analyzer 230 can determine that a change to the advertising spending has taken placed on the 12^{th} day (hereafter “post-change spend period”). Specifically, because the percentage change in the average daily spending between the pre-spend change period 412 and the post-spend change period 414 exceeds more than, for example, a few percent (or other predetermined threshold), the analyzer 230 can detect that a significant spending change has occurred. Similarly, where a significant increase (e.g., 50% or more) in advertising spending has occurred (e.g., as shown by the average spending line 406), the analyzer 230 also can deduce that the advertiser has increased the advertising spending.

Referring back to FIG. 3, at 304, a model based on the identified campaign information can be developed. In some implementations, the average daily spending in the pre-spend change period 412 and the post-spending change period 414 can be used as model data for developing the model. The volume of organic impressions and seasonality factors also can be used as model data. Specifically, in developing the model, the analyzer 230 can utilize the average daily spending during the pre-spend change period 412 to predict the volume of total clicks the advertiser could have obtained in the post-spend change period 414 had the advertiser maintained the previous advertising spending. For example, as shown in FIG. 4, the model can analyze the average daily spending during the pre-spend change period 412, from which the analyzer 230 can generate a modeled spending line 408 that closely models the average daily spending during the pre-spend change period 412 (e.g., as if no spending change has occurred). In addition to the average daily spending during the pre-spend change period 412 and post-spend change period 414, in some implementations, other data such as organic impression volume and seasonality factors such as day of week also can be used to develop the model.

Referring again to FIG. 3, at 306, based on the developed model, a number of total clicks that would have been received in the second period (e.g., post-spend change period 414) based on a first advertising spending (e.g., before changing the advertising spending) in the first period (e.g., pre-spend change period 412) and a number of total clicks that would have been received in the second period based on a second advertising spending (e.g., after changing the advertising spending) in the second period. In some implementations, both the number of paid clicks (e.g., generated from sponsored or paid ads) and organic clicks (e.g., generated from natural or organic searches) to be received in the second period can be predicted. For example, the analyzer 230 can predict, based on the developed model, a number of paid clicks and organic clicks to be received in the post-change spend period 414 using the average daily spending during the pre-spend change period 412. As an example, the modeled spending line 408 shown in FIG. 4, which is predicted based on the model, indicates a predicted average of daily spending over the post-spend change period 414. In some implementations, the model also can be configured to predict paid clicks and organic clicks separately (e.g., as opposed to the number of total clicks).

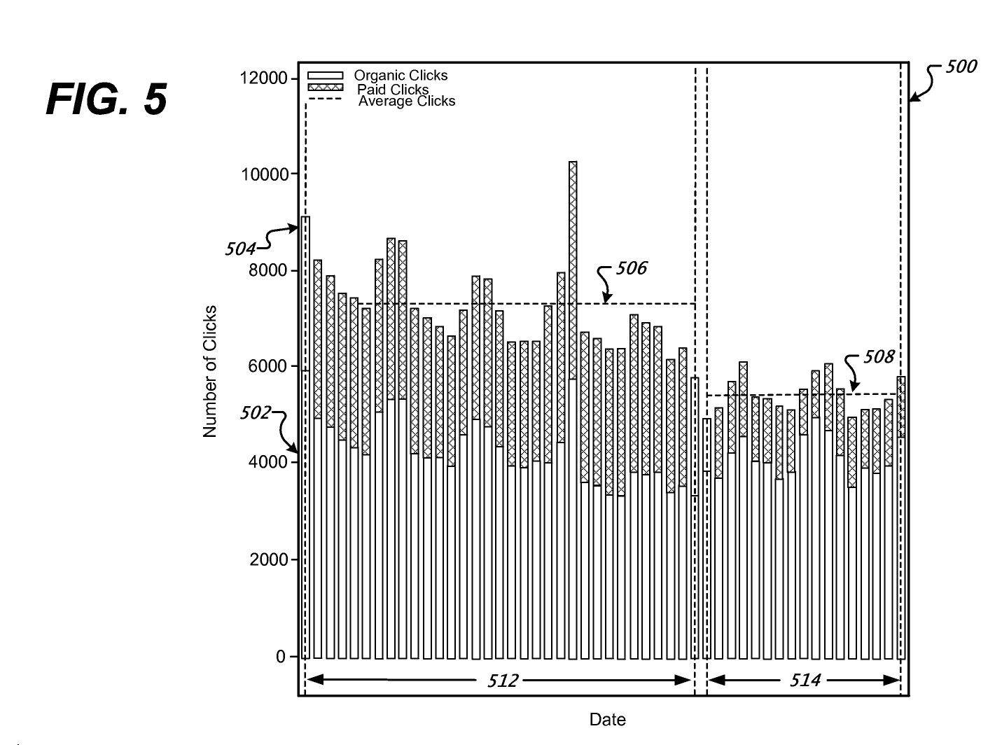

Setting the advertising spending in the post-spend change period 414 allows the analyzer 230 to predict a total number of clicks (to be discussed in greater detail later) that would have been generated had there been no change in advertising spending. The predicted number of total clicks after a change has been made to the advertising spending (e.g., at one spending level) can then be compared with the predicted number of total clicks before the change was made to the advertising spending (e.g., at a different spending level) to determine the loss (or gain) of clicks resulting from the change in advertising spending (hereinafter “total click loss”). FIG. 5 is an example of a bar chart 500 showing a total number of clicks received during a pre-spend change period 512 and a total number of clicks received during a post-spend change period 514. While the description below pertains to the determination of total click loss, the same also can be applied to the determination of total click gain.

As shown in FIG. 5, the bar chart 500 shows the evolution of both natural and paid traffic patterns to, for example, an advertiser's business web site. Specifically, the bar chart 500 illustrates a total number of clicks including organic clicks 502 (e.g., generated from organic search results) and paid clicks 504 (e.g., generated from sponsored ads) received on a daily basis over a given period. Line 506 denotes an average number of total clicks received during the pre-spend change period 512, and line 508 denotes an average number of total clicks received during the post-spend change period 514.

As shown, the difference between the line 506 and the line 508 indicates the average number of total clicks has drastically decreased (e.g., by more than 1500 total clicks), as might be anticipated when the advertiser has significantly decreased the advertising spending. Also, as shown in the bar chart 500, paid clicks 504 represent approximately 40% of the advertiser's total traffic prior to implementing changes to the advertising spending in the pre-spend change period 512. After the advertiser has reduced the advertising spending, the total number of paid clicks 504 has sharply reduced (e.g., representing only 20% of the advertiser's total traffic), an indication that the decrease in advertising spending has adversely affected the advertiser's overall traffic. Because the number of organic clicks 502 generated from organic traffic within the post-change spend period 514 remains relatively consistent, the advertiser in this example did not recover any of the lost clicks from the organic search results. The incremental value of the paid clicks, in this example, is therefore high (e.g., close to 100%) because the advertiser has lost a significant number of paid clicks that were not recovered through organic traffic. Based on the foregoing data, the advertiser can realize the true value of its spending adjustment by learning how many overall clicks has been lost or gained when deciding either to increase or decrease advertising spending.

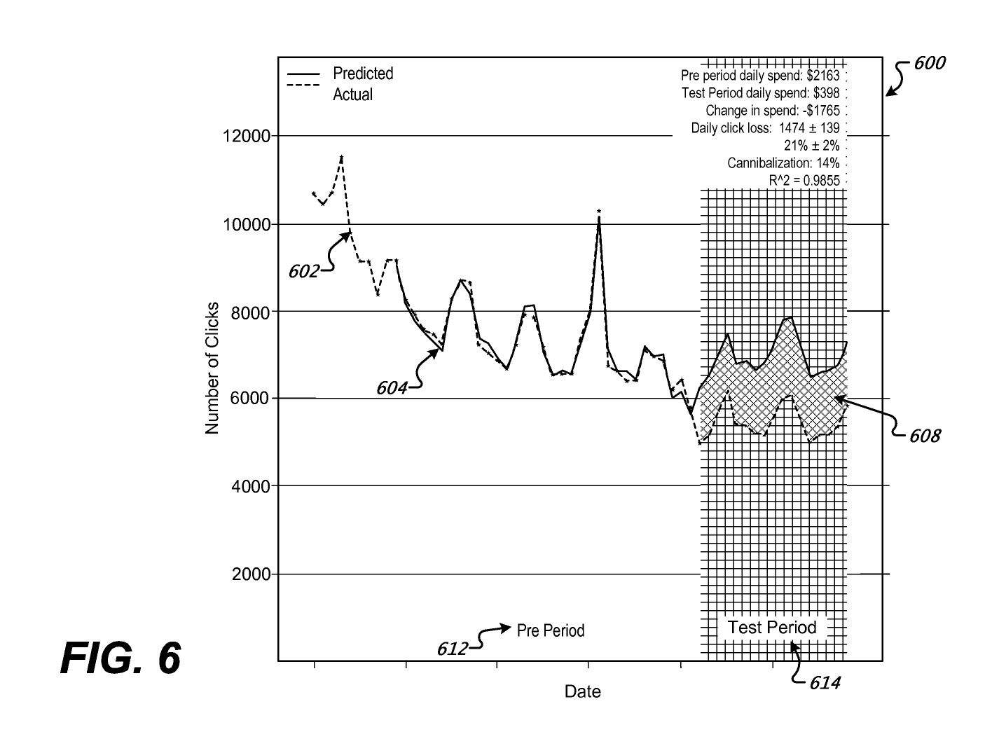

FIG. 6 is an example of a total clicks model graph 600 showing traffic generated by organic searches and paid searches to an advertiser's web site. As shown, the total clicks model graph 600 shows a dash line 602 and a solid line 604. The dash line 602 represents the actual traffic to the advertiser's web site, and the solid line 604 represents the model prediction (e.g., as predicted by the analyzer 230 based on the model data) of the number of total clicks that would have been generated had the advertising spending remained unchanged. Data spanning the dash line 602 can be collected by the analyzer 230 on a daily basis or over a particular period (e.g., either by monitoring the traffic to the advertiser's web site, from the rate at which the advertiser's budget is depleted, or other data collection processes). As shown, the solid line 604 fits relatively well over the dash line 602 during the pre-spend change period 612, indicating that the model is relatively accurate in predicting the number of total clicks received during the same period. In the post-spend change period 614 after the advertiser has made changes to the advertising spending, the solid line 604 deviates from the dash line 602 (e.g., the data model of which can be predicted by the analyzer 230). The shaded area 608 bound by the dash line 602 and the solid line 604 thus represents a predicted difference of the predicted clicks between two different spending levels (or the total of lost clicks as a direct result of the change in advertising spending).

The analyzer 230 can model the total clicks that an advertiser would have received if the advertiser had maintained the current spending level from the pre-spend change period 612 to the post-spend change period 614. Data presented in the total clicks model graph 600 can be used to calculate the total impact resulting from changes to advertising spending, taking into account the cannibalization rate, or the rate at which organic clicks are replacing or lost to paid clicks. The model expressed in the total clicks model graph 600 also can consider seasonality and fluctuations in the data that would potentially drown out the effect of the change in advertising spending, thus aiding the advertiser in making an accurate determination as to whether the spending adjustment is worthwhile.

Referring back to FIG. 3, at 310, a total click change (e.g., a total click loss or a total click gain) resulting from the change in advertising spending can be determined based on the predicted number of total clicks associated with the first advertising spending and the second advertising spending (e.g., predicted number of total clicks that would have bee received in the post-spend change period had there been a change to the advertising spending and that would have been received in the post-spend change period had there not been a change to the advertising spending). As discussed above, the predicted number of total clicks can be obtained using model data of the model developed by the analyzer 230. For example, the analyzer 230 can predict, based on the developed model, a number of paid clicks and organic clicks to be received in a post-change spend period using the average daily spending allocated to a pre-spend change period (e.g., before the spending change occurs) as well as that based on the new advertising spending specified by the advertiser in initiating the change in advertising spending.

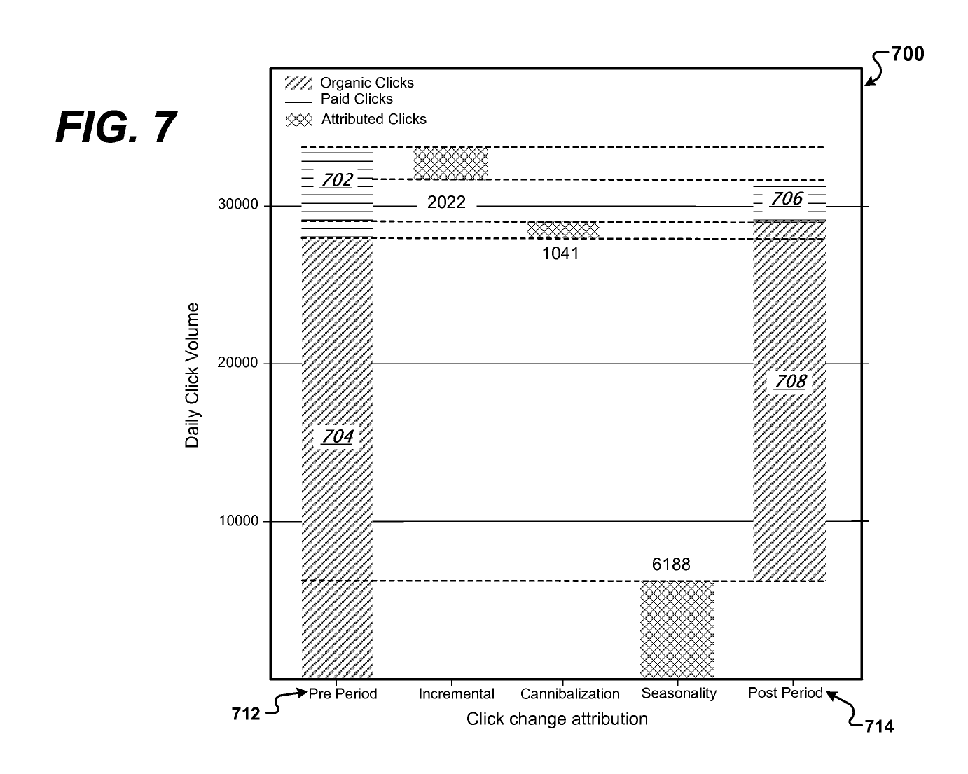

In some implementations, the analyzer 230 can determine a number of organic clicks gained as a result of the change in advertising spending. Based on the number of organic clicks gained, the analyzer 230 can determine (e.g., by prediction with a high confidence level) the total click loss by considering the predicted number of total clicks to be received in the post-spend change period associated with the two advertising spending levels, and the number of organic clicks gained from organic traffic after the advertising spending has changed. FIG. 7 is an example of a bar graph 700 showing the number of organic clicks gained from and the number of paid clicks list lost to organic traffic after the advertising spending has changed.

As shown in FIG. 7, paid clicks 702 received during the pre-spend change period 712 and paid clicks 706 received during the post-spend change period 714 (e.g., as modeled by the analyzer 230) differ by a loss of 3,063 in paid clicks (e.g., the combination of “2022” paid clicks and “1041” paid clicks). The loss of 3,063 in paid clicks can be seen as negatively attributed to the reduction in advertising spending. However, due to the spending change, the number of organic clicks 704 received during the pre-spend change period 712 has increased, as shown by the number of organic clicks 708 received during the post-spend change period 714, by a gain of “1041” in organic clicks. The gain of “1041” in organic clicks thus can be seen as positively attributed to the reduction in advertising spending.

In all, while 3,063 in total clicks including paid clicks and organic clicks have been lost after advertising spending has been reduced, only 2,022 of the total clicks are incremental due to the spending change, as 1,041 clicks have been cannibalized or recovered through increases in organic clicks. The incremental CPC can be viewed as the CPC of predicted total clicks gained or lost only as a result of the change in advertising spending. The incremental CPC can be calculated based on the change in spending and the change in predicted total clicks (e.g., dividing the change in spending by the change in total clicks). For example, assuming the spending level in a pre-spend change period is $4,095 and the spending level in a post-spend change period is $2,022, the incremental CPC would be $2.02 (e.g., $4,095/$2,022).

From the bar graph 700, the actual decrease in paid clicks spanning from the pre-spend change period 712 and the post-spend change period 714 can be broken into two parts; namely, the incremental number of clicks due to the change in spending, and the number of clicks cannibalized to organic traffic, with the remaining differences of 6,168 in total clicks being attributed to seasonality (or other variance) in organic clicks.

Referring back to FIG. 3, at 312, the cannibalization rate can be determined based on the total click change. For example, in FIG. 7, assuming the advertising spending for the pre-spend change period 712 is $13,537 and the advertising spending for the post-spend change period 714 is $9,442, then the change in spending is a drop of $4,095, which represents 30% in spending change (e.g., $4,095/$13,537). Because the advertiser should have lost 3,063 in total clicks due to the spending change but the projected click loss is only 2,022 in total clicks (with the difference recovered through organic clicks), the incremental value is only 64% (e.g., with 22% in deviation). From the incremental value, the cannibalization rate (e.g., that represents the rate at which organic clicks are replacing (or lost) to paid traffic) is 36%.

As discussed above, the cannibalization rate can reflect a rate at which a total click change (e.g., a total click loss or a total click gain) can be offset by organic clicks gained (or lost_during the post-spend change period. In addition to the cannibalization rate, the analyzer 230 also can generate one or more entry reports for presentation to the advertiser. For example, the analyzer 230 can display aggregated budgets, throttled impressions (e.g., a percentage of impression share lost to budget change as defined by dividing the number of throttled impressions due to spending change by the number of total possible impressions), bid changes (e.g., the count of the number of positive and negative bid changes made over a particular period), total active campaigns with impressions, total active ad groups with impressions, and total active keyword counts to enable an advertiser or advertising managers to manage various advertising variables when a given change happens.

### Generic Computer System

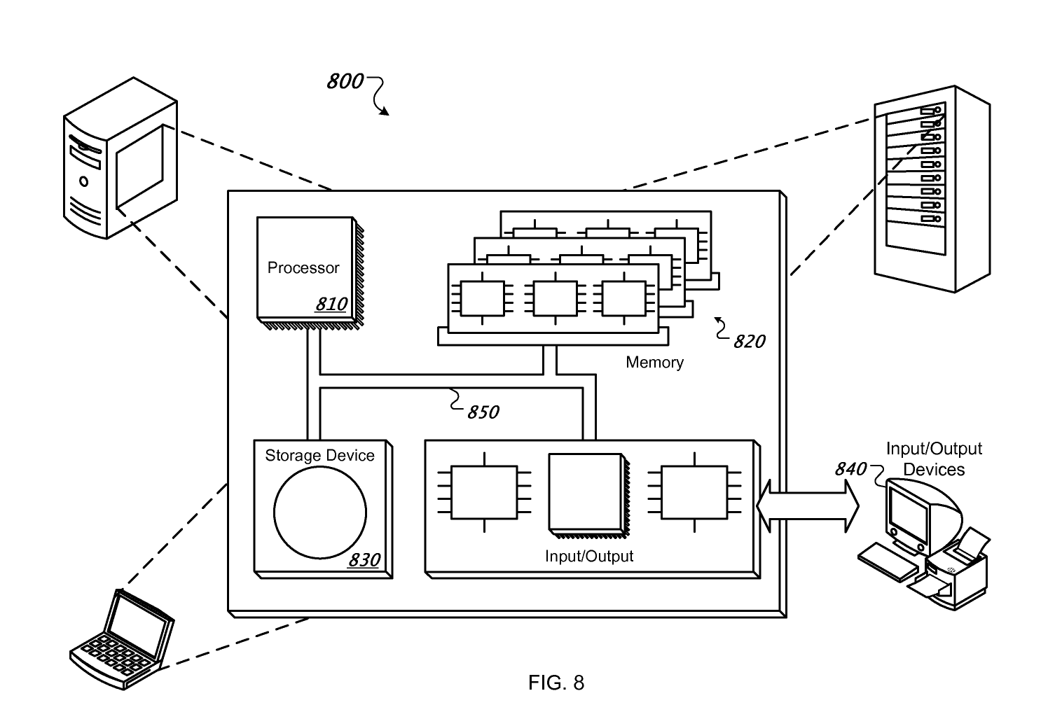

FIG. 8 is a block diagram of generic processing device that may be used to execute methods and processes disclosed. The system 800 may be used for the operations described in association with the method 300 according to one implementation. The system 800 may also be used for the operations described in association with the method 400 according to another implementation. For example, the system 800 may be included in either or all of the CMS 106, the publishers 104, and the advertisers 102.

The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In some implementations, the memory 820 is a volatile memory unit. In other implementations, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device. The storage device 830 may be used, for example, to store information in the content repository 124, and the ad repository 126.

The input/output device 840 provides input/output operations for the system 800. In one implementation, the input/output device 840 includes a keyboard and/or pointing device. In another implementation, the input/output device 840 includes a display unit for displaying graphical user interfaces.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

The features described may be implemented in digital electronic circuitry, or in computer hardware, firmware, software, or in combinations of them. In some implementations, the apparatus may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output. In other implementations, the apparatus may be implemented in a computer program product tangibly embodied in an information carrier, e.g., in a propagated signal, for execution by a programmable processor.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The term “system” encompasses all apparatus, devices, and machines for processing data, including by way of example a programmable processor, a computer, or multiple processors or computers. The system can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
identifying campaign information associated with an advertising campaign including identifying information associated with a change in advertising spending between a first period and a second period;
developing a model based on the identified campaign information;
predicting, based on the developed model, a number of total clicks that would have been received in the second period based on a first advertising spending in the first period, and a number of total clicks that would have been received in the second period based on a second advertising spending in the second period;
determining a total click change resulting from the change in advertising spending based on the predicted number of total clicks associated with the first advertising spending and the second advertising spending; and
determining a cannibalization rate based on the total click change.

2. The method of claim 1, where predicting the number of total clicks that would have been received includes predicting a number of paid clicks and organic clicks that would have been received in the second period.

3. The method of claim 2, where predicting the number of paid clicks and organic clicks includes predicting the number of paid clicks separately from predicting the number of organic clicks.

4. The method of claim 1, further comprising determining a number of organic clicks gained or lost as a result of the change in advertising spending.

5. The method of claim 4, where determining the total click change is performed based on the predicted number of total clicks associated with the first advertising spending and the second advertising spending, and the determined number of organic clicks gained or lost.

6. The method of claim 1, where determining the number of organic clicks gained as a result of the change in advertising spending includes determining a number of clicks cannibalized to organic traffic as a result of the change in advertising spending.

7. The method of claim 1, where:
identifying the campaign information includes receiving information relating to the first advertising spending in the first period;
developing the model based on the identified campaign information is performed based on the identified campaign information and the information relating to the first advertising spending.

8. The method of claim 1, where identifying information associated with a change in advertising spending includes determining an average daily spending over a predetermined interval that includes the first period and the second period.

9. The method of claim 8, further comprising:
detecting the change in advertising spending based on the determined average daily spending, the change exceeding a predetermined threshold;
identifying a date on which the detected change in advertising spending occurs; and
identifying the first period and the second period based on the identified date.

10. The method of claim 1, where determining the total click change resulting from the change in advertising spending includes determining an incremental value for organic clicks received from organic traffic and paid clicks received from paid traffic.

11. The method of claim 10, where determining the cannibalization rate includes determining a rate at which the organic clicks are replacing or lost to the paid clicks resulting from the change in advertising spending, the rate determined based at least in part on the incremental value.

12. The method of claim 1, where determining the cannibalization rate includes determining a rate at which the total click change is offset by organic clicks gained or lost during the second period.

13. A system comprising:
a database for storing campaign information associated with an advertising campaign; and
an analyzer configured to:
identify campaign information associated with an advertising campaign including identifying information associated with a change in advertising spending between a first period and a second period;
develop a model based on the identified campaign information;
predict, based on the developed model, a number of total clicks that would have been received in the second period based on a first advertising spending in the first period, and a number of total clicks that would have been received in the second period based on a second advertising spending in the second period;
determine a total click change resulting from the change in advertising spending based on the predicted number of total clicks associated with the first advertising spending and the second advertising spending; and
determine a cannibalization rate based on the total click change.

14. The system of claim 13, where the predicted number of total clicks that would have been received includes a predicted number of paid clicks and organic clicks that would have been received in the second period.

15. The system of claim 13, where the analyzer is configured to determine a number of organic clicks gained or lost as a result of the change in advertising spending.

16. The system of claim 15, where the analyzer is configured to determine the total click change based on the predicted number of total clicks associated with the first advertising spending and the second advertising spending, and the determined number of organic clicks gained or lost.

17. The system of claim 13, where the number of organic clicks gained as the result of the change in advertising spending includes a number of clicks cannibalized to organic traffic as a result of the change in advertising spending.

18. The system of claim 13, where the identified campaign information includes information relating to the first advertising spending in the first period; and
where the analyzer is configured to develop the model based on the identified campaign information is performed based on the identified campaign information and the information relating to the first advertising spending.

19. The system of claim 13, where the analyzer is configured to detect the change in advertising spending based on an average daily spending over a predetermined interval that includes the first period and the second period.

20. The system of claim 19, where the analyzer is configured to:
detect the change in advertising spending based on the determined average daily spending, the change exceeding a predetermined threshold;
identify a date on which the detected change in advertising spending occurs; and
identify the first period and the second period based on the identified date.

21. The system of claim 13, where the analyzer is configured to determine the total click change resulting from the change in advertising spending based on an incremental value for organic clicks received from organic traffic and paid clicks received from paid traffic.

22. The system of claim 21, where the analyzer is configured to determine the cannibalization rate based on a rate at which the organic clicks are replacing or lost to the paid clicks resulting from the change in advertising spending, the rate determined based partially on the incremental value.

23. The system of claim 13, where the analyzer is configured to determine the cannibalization rate based on a rate at which the total click change is offset by organic clicks gained or lost during the second period.

24. A computer-readable medium having instructions stored thereon, which, when executed by a processor, causes the processor to perform operations comprising:
identifying campaign information associated with an advertising campaign including identifying information associated with a change in advertising spending between a first period and a second period;
developing a model based on the identified campaign information;
predicting, based on the developed model, a number of total clicks that would have been received in the second period based on a first advertising spending in the first period, and a number of total clicks that would have been received in the second period based on a second advertising spending in the second period;
determining a total click change resulting from the change in advertising spending based on the predicted number of total clicks associated with the first advertising spending and the second advertising spending; and
determining a cannibalization rate based on the total click change.
